(19) United States
(12) Patent Application Publication
(10) Pub. No.: US 2018/0125056 A1
(43) Pub. Date: May 10, 2018

(54) RODENT TRAP

(71) Applicant: Michael G. Hetman, Otwell, IN (US)

(72) Inventor: Michael G. Hetman, Otwell, IN (US)

(21) Appl. No.: 15/345,713

(22) Filed: Nov. 8, 2016

(51) Int. Cl. A01M 23/24; A01M 23/30

(52) U.S. Cl. CPC A01M 23/245; A01M 23/30

(57) ABSTRACT

This application claims a device which increases the lethality of conventional spring loaded rodent traps. The device serves to entice and hold a rodent on the trap in a position most lethal to the rodent when the trap is sprung.

### BACKGROUND

### Field of the Invention

The present invention relates to rodent traps, and more particularly to an improvement to common spring loaded mouse and rat traps or “snap traps”.

### Description of Related Art

Currently spring loaded rodent traps allow the rodent to approach the bait from many different angles. This increases the likelihood that when the trap snaps, it will not be a fatal snap.

### SUMMARY

This invention controls a rodent's directional access to the bait on the trap. The invention is akin to funnel that vectors the rodent precisely so as to position it consistently in the spring loaded hammer's lethal impact and clamping zone. Since the bait is enclosed inside, the “Vector Funnel” or Funnel has as an additional benefit of reduced accidental triggering by humans handling a loaded trap. Household pets will be less likely to trigger a Funnel equipped trap. The Funnel can be installed in a fixed or temporary manner directly onto a conventional spring trap or snap trap. The invention can also be integral to a completely new trap design.

The Funnel has only one entrance and it faces and is immediately next to the hammer's lethal impact zone. The Funnel allows the trigger or catch and the hammer to operate freely without hindrance. The Funnel encloses the portion of the catch that the bait is placed on so as to entice the rodent to the device's entrance. A rodent can only access the bait on the catch from one direction. This direction centrally intersects the hammer's lethal impact and clamping zone at one edge of the trap platform. The Funnel's inside depth will accommodate the rodent's head, neck and forelegs. The rest of the rodent would be exposed from the midsection down. The Funnel aligns the entering rodent's spine so it is perpendicular to the hammer's lethal zone before the trap is triggered. The Funnel also centrally locates the rodent inside the hammer's lethal strike zone. When the rodent triggers the trap by contacting the bait on the trigger inside the device, the hammer will release and impact and clamp onto the exposed midsection of the rodent perpendicularly to the spine for the maximum lethal effect possible in this type of trap. In a typical spring trap, without this invention, the rodent would move freely about the trap and when the trap is triggered, the results are purely random as there is no guarantee that the rodent would be in the lethal zone as required. The Funnel increases the lethal effectiveness of conventional spring traps.

The device would mimic a small tight hiding place that rodents tend to prefer, versus open space where they may vulnerable to predators, further enticing entry into the device combined with the scent of the bait inside. The rodent's whiskers come into full contact with the inner walls of the device and the platform of the trap itself due to a relatively tight fit. Many of the whiskers have a constant force applied to them from the Funnel's inner walls and therefore these whiskers may not readily detect stimuli from outside the device. Subsequently, the rodent's instinctive reaction to jump or run upon the triggering of the trap may be dulled or modified. The tight headroom inside the Funnel prevents jumping or movement in the vertical direction thereby reducing escape from the trap when triggered. Additionally, upon triggering, the rodent may find false safety by staying in the tube or pushing into it as it mimics a refuge.

The Funnel controls the rodent's movement in all directions, including upwards, upon entry into the device. The rodent can only move along one line or vector and that vector is centrally and perpendicularly positioned to the hammer for maximum lethal effect. Upon entering the device, the rodent's spine is therefore longitudinally positioned by the device along this vector thereby ensuring a mostly perpendicular hammer strike onto the spine on the exposed portion of the rodent. When the trap is triggered, the rodent cannot run forward to escape or jump up to escape as the device prevents these movements. The only direction the rodent can move after entering the device is rearward, but the speed of the hammer closing will exceed the rodent's egress speed from the Funnel thereby increasing the probability of lethal hammer impact and clamping.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIGS. 1A and 1B are perspective views of a rodent trap according to the prior art;

FIGS. 2A and 2B are perspective view of the rodent trap according to an implementation of the present principles;

FIGS. 3A and 3B show an embodiment of the vector funnel according to an implementation of the present principles; and

FIGS. 4A-4C show the operation of the rodent trap, according to an implementation of the present principles.

### DETAILED DESCRIPTION OF THE DRAWINGS

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

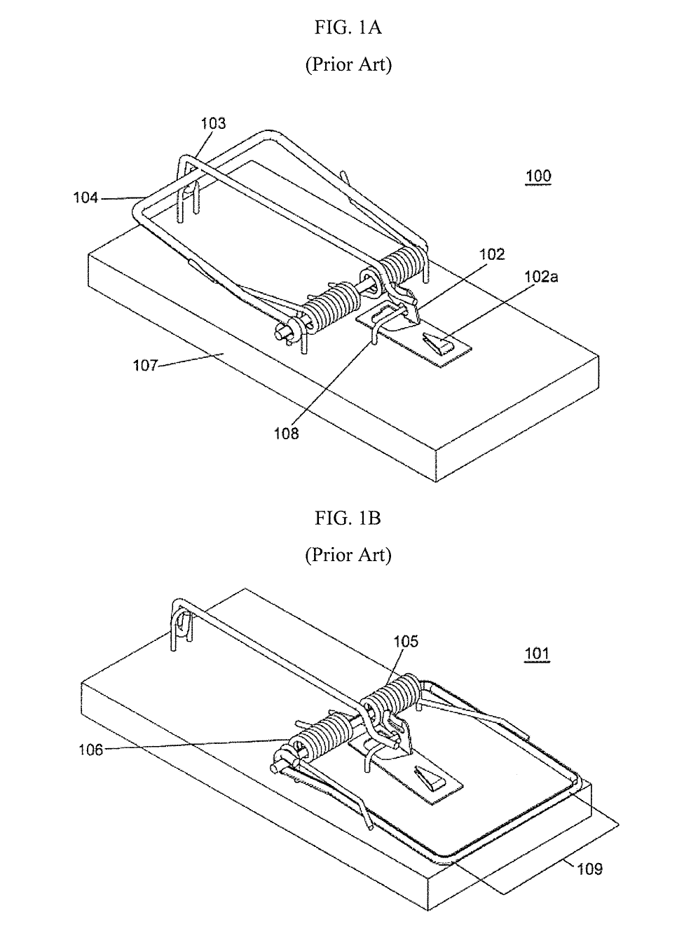

Referring to FIGS. 1A and 1B, there is shown a conventional spring-loaded rodent trap in the loaded position 100 and in the unloaded position 101 according to the prior art. The trap 100 can be scaled in size for trapping smaller mice, “mouse trap”, or larger rats, “rat trap”. The trap mechanism includes a catch 102 that grips the holding bar 103 to hold the hammer 104 down while loading springs 105 and 106 on the platform 107. Bait is placed on the catch 102 in the area of 102a where there is a raised clip to help secure the bait to the catch. Rodents can enter this embodiment from any direction and upon triggering the trap, the rodent can attempt escape in any direction including upwards by jumping. This embodiment allows the rodent to move freely over it at will. This embodiment presents no obstructions to a rodent's highly sensitive whiskers. The whiskers are free to detect and immediately react to, in milliseconds, any vibrations in the trap such as the start of the triggering sequence. Rodents can often take the bait without triggering the trap. Specifically, if the rodent does not move the catch 102 sufficiently on staple 108, in the area of the bait, 102a, the catch 102 will not release holding bar 104 and thus the spring loaded hammer 104 cannot be released and affect an impact and clamping force in the lethal zone 109. Even when triggered, rodents often escape unharmed or, at best, this embodiment kills, captures or injures rodents purely randomly.

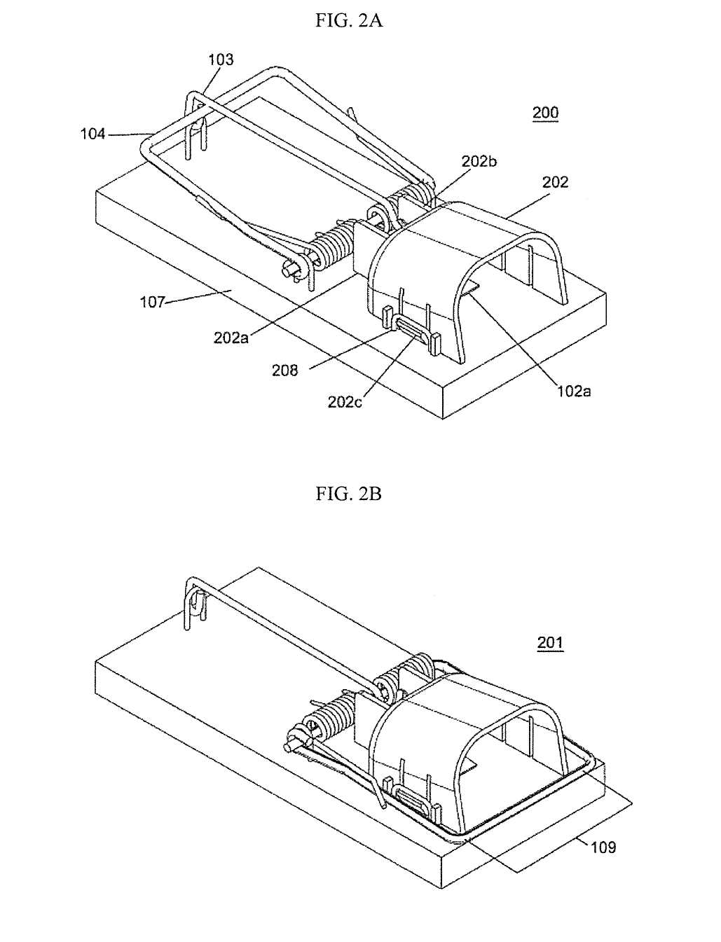

Referring to FIGS. 2A and 2B, a conventional spring-loaded rodent trap is shown with the “Vector Funnel” 202 installed. The loaded position 200 and in the unloaded position 201 are shown. The funnel 202 encloses the bait area 102a of the catch 102. The catch pivot freely on staple 108 without hindrance from funnel 202. The holding bar, upon triggering and release from the catch 7 can swing up freely without hindrance from funnel 202. Finally, the hammer 104 can rotate freely, under spring tension from springs 105 and 106, and impact and clamp the upper edge of platform 107 in the lethal impact zone 109, without interference from funnel 202. A possible method of attachment of Funnel 202 to Platform 107 is shown in 200. Squeezable tab 202c can be captured under staple 208 on both sides of the funnel 202. staple 208 can be similar to staple 108 in size and exposed height above the platform 107. The funnel 202 can be snapped into place and just as easily removed, if needed. Walls 202a and 202b are affixed to funnel 202 and serve to reduce accidental triggering of the trap by limiting access to the catch in the area between the Walls 202a and 202b. The walls 202a and 202b reduce accidental triggering by humans and household pets. The funnel 202 reduces accidental triggering by humans and household pets limiting access to the bait in area 102a. Normal human handling and placement of a loaded trap with the funnel 202 installed should result in reduced accidental triggers and related injuries.

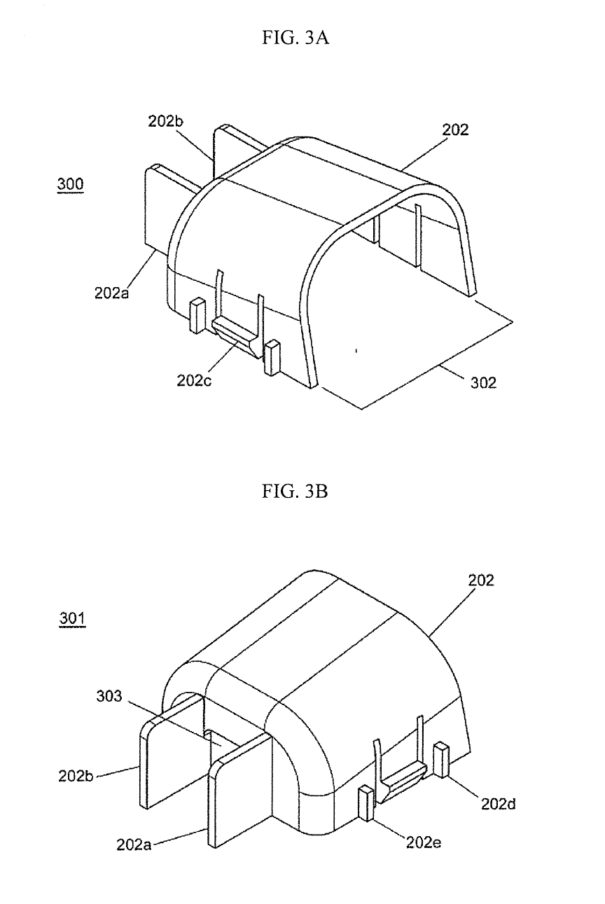

As shown in FIGS. 3A and 3B, the entrance 302 of funnel 202 is shown in 300. The inside height of funnel 202 serves to prevent the rodent from jumping upwards and escaping the trap.

The opposite side of funnel 202 is shown in 301 with the opening 303 for the catch 102 shown. Bait area 102a of catch 102 is inside funnel 202. The holding bar engages catch 102 just ahead of opening 303 and between the anti-intrusion Walls 202b and 202a. Opening 303 is as small as possible but cannot hinder the triggering operation of the trap. By design, the rodent is forced to enter the trap at entrance 302. Ribs 202e and 202d serve to fix the position of funnel 202 on platform 107 by contacting the outsides of staple 208.

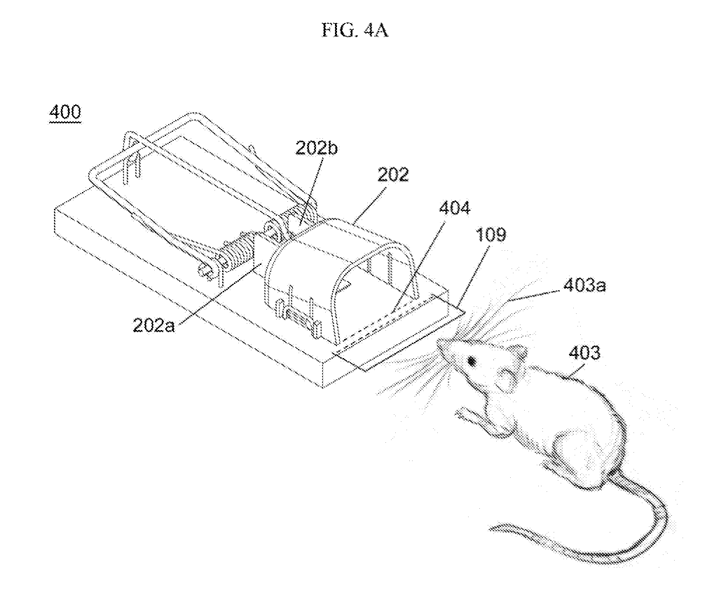

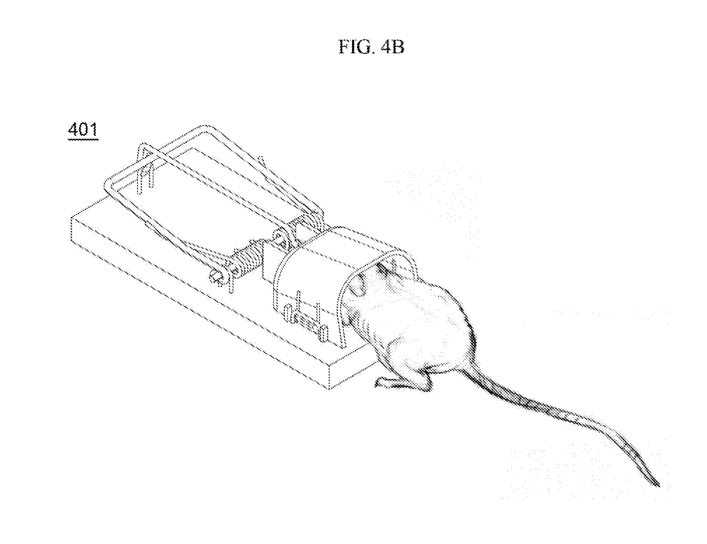

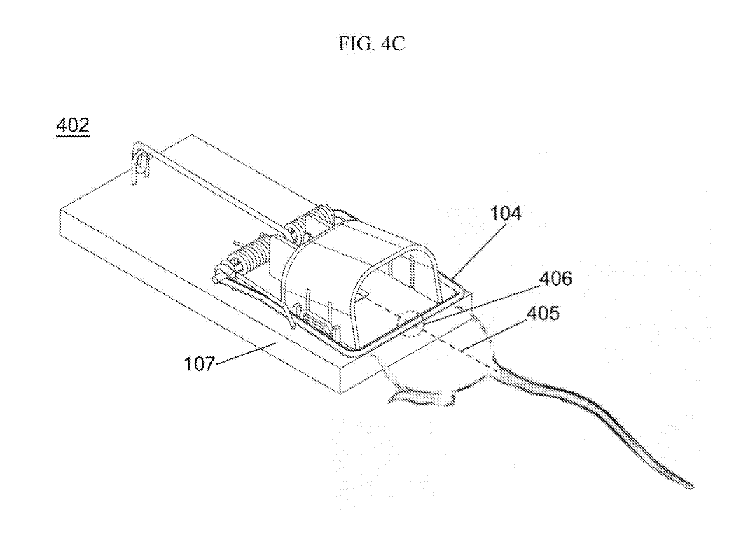

FIGS. 4A-4C show a conventional spring-loaded rodent trap with funnel 202 installed. FIGS. 4A (400) and 4B (401) show the trap in a loaded position ready to trap a rodent. In FIG. 4A, a rodent 403 approached the trap on the entrance side of the funnel 202. At this point in time, the rodent's 403 whiskers 403a are free to move and sense normally at the rodent's will. The threshold 404 of the funnel 202 is placed parallel and close to the hammer 104 lethal impact and clamping zone 109 for maximum and quickest possible lethal effect.

In FIG. 4B, the Rodent 403 enters the funnel 202 by crossing the threshold 404 in order to access the bait on bait area 102a inside the funnel 202. The rodent 403 must place its head and neck into the funnel 202 to reach and inspect the bait inside. Now the whiskers 403a are making contact with the inside walls of funnel 202 and the platform 107 inside funnel 202. The whiskers 403a are free to receive stimuli through the air as before the Rodent 403 entered the funnel 202. Rodents tend to prefer narrow spaces that mimic hiding places versus open spaces where they may be more vulnerable to predators. Funnel 202 may therefore reduce the response time or alter the response behavior of a rodent so as to keep the rodent inside the funnel 202 as long as possible upon the triggering of the trap.

FIG. 4C (402) shows the trap with funnel 202 installed in the unloaded position after trapping a rodent. Funnel 202 vectored rodent 403 directly over the lethal impact and clamping zone 109. The rodent's, 403, spinal direction 405 is aligned perpendicularly and centrally to the lethal zone 109. Hammer 104 impacted and clamped onto the spine in area 406 for quickest and most humane kill possible.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

What is claimed is:

1. A rodent trap comprising:
a trap mechanism having an area for receiving bait; and
a funnel positioned adjacent the trap mechanism and being configured to control a rodent's directional access to the bait.
